(19) United States
(12) Patent Application Publication
(10) Pub. No.: US 2010/0254479 A1
(43) Pub. Date: Oct. 7, 2010

(54) METHOD FOR DETERMINING A MODULATION AND CODING SCHEME

(75) Inventors: YEN CHIN LIAO, HSINCHU COUNTY (TW); YUNG SZU TU, HSINCHU COUNTY (TW); CHENG HSUAN WU, HSINCHU COUNTY (TW); JIUNN TSAIR CHEN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/553,838

(22) Filed: Sep. 3, 2009

(30) Foreign Application Priority Data
Apr. 3, 2009 (TW) 098111111

(51) Int. Cl. H04L 27/00

(52) U.S. Cl. 375/295

(57) ABSTRACT

A method for determining a modulation and coding scheme comprises the steps of: transmitting signals with different modulation and coding schemes and adjusting weighting of each modulation and coding scheme based on the quality of transmitted signals on a receiving end; adjusting the weighting of each modulation and coding scheme based on suggested modulation and coding schemes; determining a modulation and coding scheme to use according to the weighting of each modulation and coding scheme.

### BACKGROUND OF THE INVENTION

1. Field of the Invention

The present invention relates to a method for determining a modulation and coding scheme of a communication system, and more particularly, to a method for determining a modulation and coding scheme based on suggested modulation and coding schemes.

2. Description of the Related Art

In Wi-Fi wireless local area networks, such as those following the IEEE 802.11n standard, a receiver is required to suggest transmitter modulation and coding schemes (MCS) based on transmission environment, and the MCS adopted by the transmitter is selected according to variations in the transmission environment so as to maintain optimal transmission throughput.

Among the many methods for determining an MCS, automatic rate fallback (ARF) algorithm is a widely used technique. The ARF method establishes a priority order for every MCS for the applied communication system, and calculates the packet error rate (PER) for a fixed amount of time in the receiver. If, within a fixed amount of time, the PER in the receiver exceeds an upper threshold, an MCS with a lower data rate is adopted according to the priority order. If, in the fixed amount of time, the PER in the receiver drops below a lower threshold, another MCS with a higher data rate is adopted according to the priority order.

Another popular MCS selection method is based on the transmission environment; that is, selecting the MCS for the transmitter based on the signal to noise ratio (SNR). For example, FIG. 1 shows experiment results of the optimum MCSs for different SNRs in an IEEE 802.11n wireless communication system. As shown in FIG. 1, the system structure is a double antenna system, wherein a double transmission antenna and a double receiving antenna are included. There are 16 MCSs available, wherein number 0 to number 7 are single spatial stream MCSs, and number 8 to number 15 are double spatial stream MCSs. The receiver stores the experiment results shown in FIG. 1 in a table and selects the MCS adopted by the transmitter according to the stored experiment results.

In addition, as shown in FIG. 2, following the IEEE 802.11n standard, a transmitting end 201 can transmit a request signal MRQ to a receiving end 202 for suggested MCSs (MFB). Then the transmitting end 201 could set the MCS of signal transmission to be the same as the received MFB. However, there are disadvantages to simply substituting the MFB as the MCS of the transmitting end 201. If a majority of the MFBs are different from the previous one; that is, if the MFBs transmitted by the receiving end 202 change too rapidly, not only does the transmitting end 201 have to adapt to the MFBs too rapidly, but these MFBs are be too divergent to be reliable. On the other hand, if only the two aforementioned methods are used for determining an MCS without referring to the MFBS, then the valuable information provided by the receiving end 202 is wasted.

Therefore, there is a need to design a method for determining an MCS based on the MFBs.

### SUMMARY OF THE INVENTION

The method for determining an MCS according to one embodiment of the present invention comprises the steps of: transmitting signals with different MCSs and adjusting weighting of each MCS based on the quality of received signals; adjusting the weighting of each MCS based on suggested MCSs; and determining an MCS to use according to the adjusted weighting of each MCS.

The method for determining an MCS according to another embodiment of the present invention comprises the steps of: transmitting a signal with an MCS and receiving an ACK signal in response to the transmitted signal; increasing weightings of those MCSs with data rate higher than that of the selected MCS, decreasing weightings of those MCSs with data rates lower than that of the selected MCS and repeating the transmitting step if the ACK signal is 1; increasing weightings of those MCSs with data rates lower than that of the selected MCS, decreasing weightings of those MCSs with data rates higher than that of the selected MCS and repeating the transmitting step if the ACK signal is 0; increasing weighting of the MCS corresponding to a suggested MCS if the suggested MCS is received; selecting an MCS according to the adjusted weightings of the MCSs and repeating the transmitting step; and determining an MCS to use according to the adjusted weightings of the MCSs.

### BRIEF DESCRIPTION OF THE DRAWINGS

The objectives and advantages of the present invention will become apparent upon reading the following description and upon referring to the accompanying drawings of which:

FIG. 1 shows experiment results of the optimum MCSs for different SNRs;

FIG. 2 shows a transmitting end and a receiving end exchanging request signal and MFBs; and

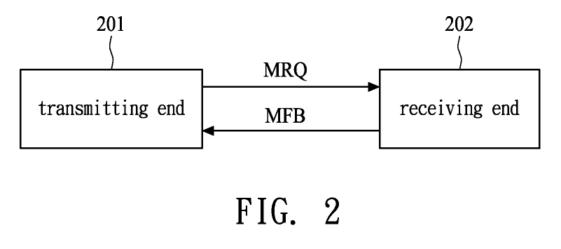

FIG. 3 shows the flow chart of a method for determining an MCS according to an embodiment of the present invention.

### DETAILED DESCRIPTION OF THE INVENTION

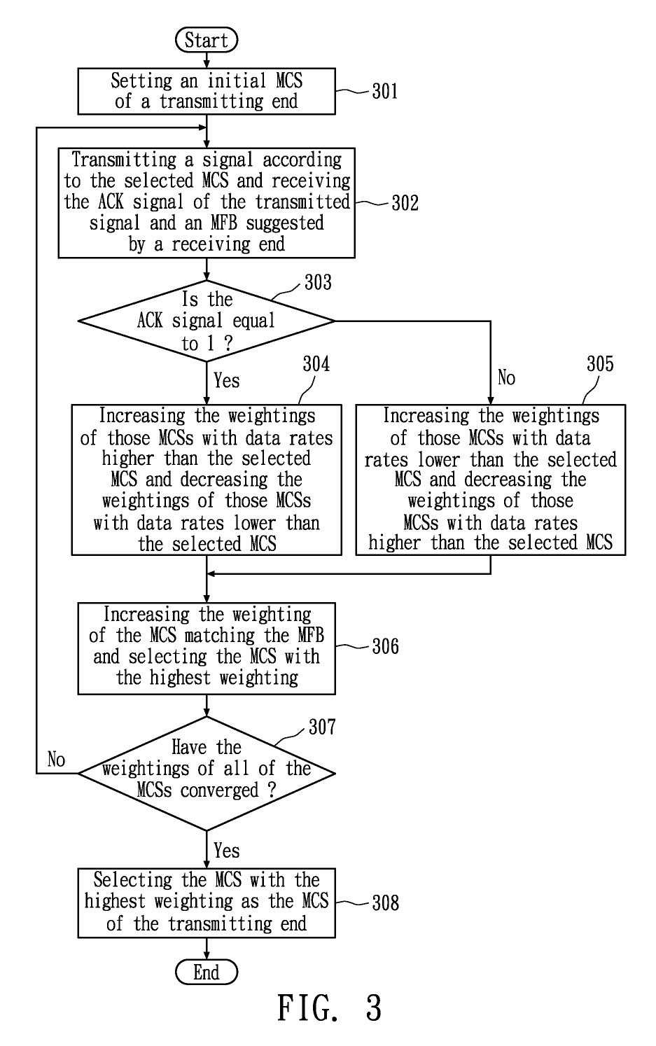

FIG. 3 shows the flow chart of a method for determining an MCS according to an embodiment of the present invention. In step 301, an initial MCS of a transmitting end is set, and step 302 is executed. In step 302, a signal is transmitted according to the selected MCS, the ACK signal response to the transmitted signal and an MFB suggested by a receiving end are received, and step 303 is executed. In step 303, the value of the ACK signal received in response to the transmitted signal is determined. If the value of the ACK signal is 1, step 304 is executed; otherwise, step 305 is executed. In step 304, the weightings of those MCSs with data rates higher than the selected MCS are increased, the weightings of those MCSs with data rates lower than that of the selected MCS are decreased, and step 306 is executed. In step 305, the weightings of those MCSs with data rates lower than that of the selected MCS are increased, the weightings of those MCSs with data rates higher than that of the selected MCS are decreased, and step 306 is executed. In step 306, the weighting of the MCS matching the MFB is increased, the MCS with the highest weighting is selected, and step 307 is executed. In step 306, if there is more than one MCS with the highest weighting, the one with the highest data rate is selected. In step 307, it is determined whether the weightings of all of the MCSs have converged. If the result is positive, step 308 is executed; otherwise, step 302 is re-executed. In step 308, the MCS with the highest weighting is selected as the MCS of the transmitting end.

In some embodiments of the present invention, particularly those applied to multiple antenna systems, a single spatial stream MCS is set as the initial MCS in step 301. After the weightings of all of the MCSs have been determined to be convergent in step 307, the number of the spatial streams is incremented, and step 301 is re-executed.

The following example illustrates a communication system determining an MCS according to the method for determining an MCS shown in FIG. 3, wherein the communication system exhibits at least two antennas, and is in accordance with the IEEE 802.11n standard. The communication system has 16 MCSs, of which eight are single spatial stream MCSs (MCS0 to MCS7), and eight are double spatial stream MCSs (MCS8 to MCS15). At first, the communication system initializes a vector V1 with length of 8 bits and values of all zeroes. That is, V1=[0, 0, 0, 0, 0, 0, 0, 0], wherein all of the values represent the weightings of the MCSs MCS0 to MCS7, and these MCSs MCS0 to MCS7 are arranged according to data rate, so the MCS with the lowest data rate is listed first and the MCS with the highest data rate is listed last.

In step 301, an initial MCS of single spatial stream signal, such as MCS4, is set. In step 302, a signal is transmitted according to the selected MCS MCS4, and the ACK signal in response to the transmitted signal and an MFB suggested by a receiving end, such as MCS3, are received. In step 303, the value of the ACK signal is determined to be 1, and step 304 is executed. The calculating process in steps 304 and 305 is based on the following pseudo code:

```
If (Ack == 1)
  V1[m]= V1[m]+1; for all m >= mcs
  V1[m]= V1[m]−1; for all m < mcs
Else
  V1[m]= V1[m]−1; for all m >= mcs
  V1[m]= V1[m]+1; for all m < mcs, wherein Ack is the ACK signal
of the transmitted signal, m is an integer ranging from 0 to 7, and mcs
is the selected MCS.
```

Therefore, in step 304, the values of V1[4] to V1[7] are increased, the values of V1[0] to V1[3] are decreased and thus V1 becomes [−1, −1, −1, −1, 1, 1, 1, 1].

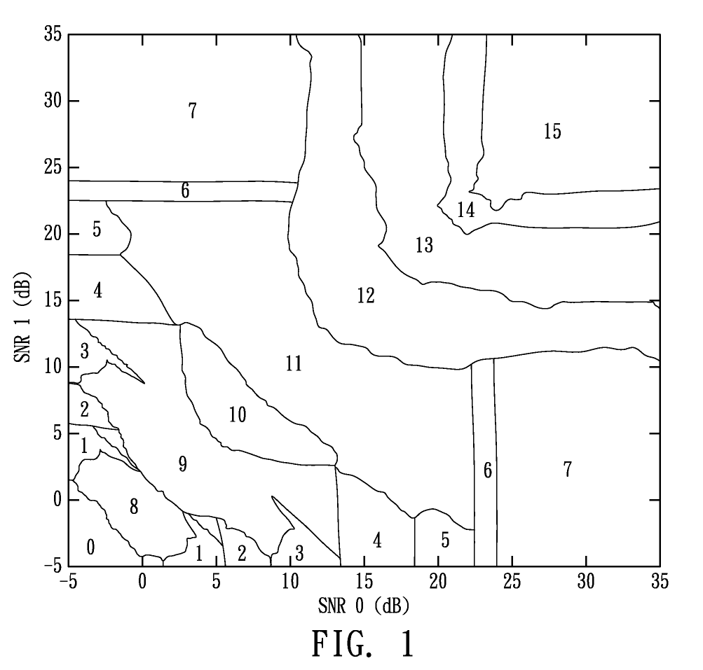

The increasing of the weighting of the MCS matching the MFB can follow the following table, wherein the table is determined according to the experiment results shown in FIG. 1.

| MFB | The increased weighting in V1 |
|---|---|
| 0 | [X, 0, 0, 0, 0, 0, 0, 0] |
| 1 | [0, X, 0, 0, 0, 0, 0, 0] |
| 2 | [0, 0, X, 0, 0, 0, 0, 0] |
| 3 | [0, 0, 0, X, 0, 0, 0, 0] |
| 4 | [0, 0, 0, 0, X, 0, 0, 0] |
| 5 | [0, 0, 0, 0, 0, X, 0, 0] |
| 6 | [0, 0, 0, 0, 0, 0, X, 0] |
| 7 | [0, 0, 0, 0, 0, 0, 0, X] |
| 8 | [X, X, 0, 0, 0, 0, 0, 0] |
| 9 | [0, X, X, X, 0, 0, 0, 0] |
| 10 | [0, 0, X, X, 0, 0, 0, 0] |
| 11 | [0, 0, X, X, X, X, 0, 0] |
| 12 | [0, 0, 0, X, X, X, X, X] |
| 13 | [0, 0, 0, 0, X, X, X, X] |
| 14 | [0, 0, 0, 0, 0, X, X, X] |
| 15 | [0, 0, 0, 0, 0, 0, X, X] |

The X symbol in the table is a constant or a variable. In this example, X is equal to 1. Therefore, after the execution of step 306, V1 becomes [−1, −1, −1, 0, 1, 1, 1, 1].

Next, the MCS with the highest weighting is selected. Since V1[4] to V1[7] all have the highest weighting 1, the MCS with the highest data rate, MCS7, is selected. In step 307, the weightings of all of the MCSs are determined as not converging, and step 302 is re-executed, wherein MCS7 is selected for the signal transmission.

After the weightings of all of the MCSs are determined as converging, there is a stable MCS with the highest weighting, such as MCS5, the number of the spatial streams is incremented to be two, and step 301 is re-executed. At this time, the communication system initializes a vector V2 with length of 9 bits and values of all zeroes. That is, V1=[0, 0, 0, 0, 0, 0, 0, 0, 0], wherein all of the values represent the weightings of the MCSs MCS8 to MCS15 and MCS5, and the order of these MCSs MCS0 to MCS7 and MCS5 is listing from the MCS with the lowest data rate to the MCS with the highest data rate.

The calculating process in steps 304 and 305 may follow the pseudo code aforementioned. The calculating process in step 306 is based on the following pseudo code:

```
  mIndex = arg min{|MFB-m|}; for m=5, 8~15
  V2[m] = V2[m]+Y; for m = mIndex
  V2[m] = V2[m]; for m ≠ mIndex, wherein mIndex is the MCSs for
which the weightings are to be adjusted, and Y is a constant or a variable.
After the weightings of all of the MCSs are determined as converging, and
there is a stable MCS with the highest weighting, such as MCS13, then
MCS13 is determined to be the MCS of signal transmission.
```

In conclusion, the method for determining an MCS of the present invention is based on MFB and an MCS adjusting method to determine the MCS of the transmitting end. In other words, the valuable information provided by the receiving end and the computing capability of the transmitting end are fully utilized such that an optimal MCS is obtained much faster than under prior methods.

The above-described embodiments of the present invention are intended to be illustrative only. Those skilled in the art may devise numerous alternative embodiments without departing from the scope of the following claims.

What is claimed is:

1. A method for determining a modulation and coding scheme, comprising the steps of:
transmitting signals with different modulation and coding schemes and adjusting weighting of each modulation and coding scheme based on the quality of received signals;
adjusting the weighting of each modulation and coding scheme based on a suggested modulation and coding scheme; and
determining a workable modulation and coding scheme according to the adjusted weighting of each modulation and coding scheme.

2. The method of claim 1, wherein the suggested modulation and coding schemes are provided by a receiving end.

3. The method of claim 1, which is utilized in a system having at least two antennas.

4. The method of claim 1, which is utilized in an IEEE 802.11n wireless communication network.

5. A method for determining a modulation and coding scheme, comprising the steps of:
transmitting a signal with a selected modulation and coding scheme (MCS) and receiving an ACK signal in response to the transmitted signal;
increasing weightings of MCSs with data rates higher than that of the selected MCS, decreasing weightings of MCSs with data rates lower than that of the selected MCS and repeating the transmitting step if the ACK signal is 1;
increasing weightings of MCSs with data rates lower than that of the selected MCS, decreasing weightings of MCSs with data rates higher than that of the selected MCS and repeating the transmitting step if the ACK signal is 0;
increasing weighting of an MCS corresponding to a suggested MCS if the suggested MCS is received;
selecting an MCS according to the adjusted weightings of the MCSs and repeating the transmitting step; and
determining a workable MCS according to the adjusted weightings of the MCSs.

6. The method of claim 5, wherein the suggested MCSs are provided by a receiving end.

7. The method of claim 5, wherein the selecting step is to select the MCS with a highest weighting.

8. The method of claim 7, wherein if there is more than one MCS with the highest weighting, the one with the highest data rate is selected.

9. The method of claim 5, wherein the determining step is to determine the MCS with a highest weighting.

10. The method of claim 5, wherein the weightings of the MCSs are recorded in a vector.

11. The method of claim 5, wherein the weightings of the MCSs with data rates higher than that of the selected MCS are incremented by 1 and the weightings of the MCSs with data rates lower than that of the selected MCS are decremented by 1 if the ACK signal is 1.

12. The method of claim 5, wherein the weightings of those MCSs with data rates lower than that of the selected MCS are incremented by 1 and the weightings of those MCSs with data rates higher than that of the selected MCS are decremented by 1 if the ACK signal is 0.

13. The method of claim 5, wherein the weighting of the MCS corresponding to a suggested MCS is increased based on experiment results of the optimum MCSs for different signal to noise ratios.

14. The method of claim 5, which is utilized in a system having at least two antennas.

15. The method of claim 5, which is utilized in an IEEE 802.11n wireless communication network.
